(19) United States
(12) Patent Application Publication
(10) Pub. No.: US 2009/0063207 A1
(43) Pub. Date: Mar. 5, 2009

(54) SYSTEM AND METHOD FOR EXCHANGING EVENT TICKETS

(76) Inventor: Jeffrey S. Brodzeller, Indianapolis, IN (US)

Correspondence Address: BARNES & THORNBURG LLP, 11 SOUTH MERIDIAN, INDIANAPOLIS, IN, 46204, US

(21) Appl. No.: 12/282,957

(22) PCT Filed: Mar. 15, 2007
(86) PCT No.: PCT/US07/06556

§ 371 Date: Sep. 15, 2008

Related U.S. Application Data
(60) Provisional application No. 60/783,249, filed on Mar. 17, 2006.

(51) Int. Cl. G06Q 30/00; G06Q 10/00

(52) U.S. Cl. 705/5; 705/1

(57) ABSTRACT

A method of exchanging event tickets may comprise determining a monetary value of at least one event ticket offered for redemption by a ticket holder, assigning a number of points equivalent to the monetary value of the at least one event ticket, and offering the number of points to the ticket holder in exchange for the at least one event ticket. A system is also provided for exchanging event tickets.

This patent application claims priority to and the benefit of U.S. provisional patent application Ser. No. 60/783,249, filed Mar. 17, 2006, the disclosure of which is incorporated herein by reference.

### FIELD OF THE INVENTION

The present invention relates generally to exchanging event tickets, and more specifically to systems and methods for exchanging event tickets.

### BACKGROUND

Secondary market ticket sales (admissions) to sporting and cultural events generate significant revenue in the United States and other countries. Currently, purchasers of tickets to these events who are unable or unwilling to use their event tickets must go through one of a variety of cash-based channels in order to receive some value in return for these tickets. Similarly, if they wish to acquire tickets for events other than those that they have already purchased, these same channels must typically be utilized. These channels include primary or initial suppliers of event tickets, ticket brokers, scalpers, and tour operators. It would accordingly be desirable to provide a mechanism for purchasers of ticket subscriptions to sporting events (such as professional and college football, basketball, baseball, hockey and soccer) and cultural events (such as opera, ballet, theater and symphony) to exchange their admission rights to those events directly for admission rights to other events and/or for other product and/or services.

### SUMMARY

The system and method disclosed herein generally allows purchasers of tickets to sporting events (such as professional and college football, basketball, baseball, hockey and soccer) and cultural events (such as opera, ballet, theater and symphony) to exchange their admission rights to those events directly for admission rights to other events, and/or for other products and/or services. A purchaser of tickets for these forms of entertainment access an event ticket exchange system to redeem tickets that they have purchased for a number of points that have been predetermined to represent the value of the tickets. Tickets are valued based on their face value and a set of criteria that serve to differentiate each event by demand, and the criteria may vary based on one or more factors including, for example, but not limited to, event type.

Members may request exchanges for available tickets via a number of interfaces including, but not limited to, the World Wide Web, telephone and/or regular mail, e.g., U.S. Postal service or other courier. Requests for particular events may be managed within a series of priority reservation periods to help facilitate access for certain members to certain types of transactions, and then in an open reservation period where tickets can be accessed by any member with enough points and appropriate access rights. Ticket request searches may return exact matches and alternatives based on user input and on other system criteria including, for example, but not limited to, member preferences, member reservation patterns and prevailing market prices to acquire tickets on behalf of members. If the desired ticket exchange is not available, a request may be entered into a queue to wait in line for access to future availability. Processes may be employed to perform a variety of functions, including, for example, ticket redemption, ticket verification, ticket valuation, ticket management and ticket fulfillment. Among other tasks, other processes may be employed to manage ticket access for specific user types and point allocations, allow users to search for eligible tickets based on user-defined criteria, offer alternatives and additional ticket options to the user based on system-defined criteria and manage member accounts including point balances, reservation histories, and open requests.

The present invention may comprise one or more of the features recited in the attached claims, and/or one or more of the following features and combinations thereof. A method of exchanging event tickets may comprise determining a monetary value of at least one event ticket offered for redemption by a ticket holder, assigning a number of points equivalent to the monetary value of the at least one event ticket, and offering the number of points to the ticket holder in exchange for the at least one event ticket.

The method may further comprise allowing the ticket holder to select or reserve at least one alternate event ticket, other product or service, and allowing the ticket holder to exchange one or more of the number of points for the selected or reserved at least one alternate event ticket, other product or service. Allowing the ticket holder to select at least one alternate event ticket, other product or service may comprise providing the ticket holder with a list of available alternate event tickets, other products or services, and allowing the ticket holder to select the at least one alternate event ticket, product or service from the list of available alternate event tickets, other products or services. Allowing the ticket holder to reserve at least one alternate event ticket, other product or service may comprise allowing the user to specify the at least one alternate event ticket, other product or service. The method may further comprise attempting to procure the reserved at least one alternative event ticket, other product or service on the open market, and allowing the ticket holder to exchange one or more of the number of points for the reserved at least one alternate event ticket, other product or service only if the reserved at least one alternative event ticket, other product or service can be procured on the open market. Attempting to procure the reserved at least one alternative event ticket, other product or service may comprise determining a maximum price for procuring the reserved at least one alternate event ticket, other product or service on the open market, and procuring the reserved at least one alternate event ticket, other product or service only if the reserved at least alternate event ticket, other product or service can be procured on the open market at a price at or below the maximum price.

The method may further comprise establishing a member account for the ticket holder that the ticket holder may use to exchange event tickets. The method may further comprise evaluating a status of the member account, and executing the determining, assigning and offering steps only if the status of the member account is in good standing.

The method may further comprise providing the ticket holder with a list of event tickets owned by the ticket holder, and allowing the ticket holder to select from the list of event tickets the at least one event ticket to offer for redemption.

Determining a monetary value of the at least one event ticket offered for redemption by the ticket holder may comprise determining a core point value of the at least one event ticket offered for redemption. Determining a core point value of the at least one event ticket offered for redemption by the ticket holder may comprise identifying one or more discounts realized by the ticket holder for the ticket holder's purchase of the at least one event ticket, and reducing the core point value of the at least one event ticket offered for redemption by the one or more identified discounts.

The method may further comprise determining a demand level of the at least one event ticket, and determining a category of the number of points based on the demand level. Assigning the number of points may comprise assigning the number of points in the determined category of the number of points.

Determining a demand level of the at least one event ticket offered for redemption by the ticket holder may comprise determining whether the event corresponding to the at least one event ticket satisfies any of a number of predefined criteria, and determining the demand level as a function of the number of predefined criteria satisfied by the event corresponding to the at least one event ticket. The event may be a sporting event and the number of predefined criteria may include whether the sporting event is a home opener. Alternatively or additionally, the number of predefined criteria may include whether the teams scheduled for the sporting event are rival teams. Alternatively or additionally, the number of predefined criteria may include whether the sporting event will include a superstar participant. Alternatively, the event may be a cultural event and the number of predefined criteria may include whether the at least one event ticket corresponds to opening night of the cultural event. In either case, the number of predefined criteria may alternatively or additionally include whether the event corresponding to the at least one event ticket is scheduled for a predefined day of the week.

The method may further comprise allowing the ticket holder to classify the at least one event ticket offered for redemption as a restricted redemption or an unrestricted redemption. The method may further comprise assigning the number of points equivalent to the monetary value of the at least one event ticket to the ticket holder upon redemption of the at least one event ticket if the redemption has been classified by the ticket holder as an unrestricted redemption. The method may further comprise assigning the number of points equivalent to the monetary value of the at least one event ticket to the ticket holder only after the at least one event ticket has been reserved by another if the redemption has been classified by the ticket holder as a restricted redemption.

The method may further comprise requiring the ticket holder to provide the at least one redeemed event ticket to a ticket exchange system. The method may further comprise analyzing the at least one redeemed ticket provided by the ticket holder to determine whether the at least one redeemed ticket provided by the ticket holder matches the at least one ticket offered for redemption by the ticket holder. The method may further comprise removing the number of points from the ticket holder's account if the at least one ticket redeemed by the ticket holder does not match the at least one ticket offered for redemption by the ticket holder. The method may further comprise analyzing the at least one redeemed ticket provided by the ticket holder to determine whether the at least one redeemed ticket provided by the ticket holder was received from the ticket holder within a specified time period. The method may further comprise removing the number of points from the ticket holder's account if the at least one ticket redeemed by the ticket holder was not received from the ticket holder within the specified time period. The method may further comprise analyzing the at least one redeemed ticket provided by the ticket holder to determine its authenticity. The method may further comprise returning the at least one redeemed event ticket to a ticket issuing authority if the at least one redeemed ticket provided by the ticket holder is not authentic. The method may further comprise making the at least one redeemed event ticket provided by the ticket holder available for reservation by another if the at least one ticket redeemed by the ticket holder matches the at least one ticket offered for redemption by the ticket holder, the at least one ticket redeemed by the ticket holder was received from the ticket holder within the specified time period, and the at least one redeemed ticket provided by the ticket holder is authentic.

The method may further comprise preparing a ticket package including the at least one redeemed event ticket along with premium member benefits if the at least one redeemed event ticket is reserved by a premium member after making the at least one redeemed event ticket provided by the ticket holder available for reservation by another, and mailing the ticket package to the premium member.

The method may further comprise preparing a ticket package including only the at least one redeemed event ticket if the at least one redeemed event ticket is reserved by a non-premium member after making the at least one redeemed event ticket provided by the ticket holder available for reservation by another, and mailing the ticket package to the non-premium member.

The method may further comprise preparing a ticket package including the at least one redeemed event ticket along with premium member benefits if the at least one redeemed event ticket is reserved by a premium member after making the at least one redeemed event ticket provided by the ticket holder available for reservation by another, prior to the event, providing the ticket package to the venue at which the corresponding event is scheduled to take place, and providing the ticket package to the premium member at the venue upon satisfactory identification of the premium member.

The method may further comprise preparing a ticket package including only the at least one redeemed event ticket if the at least one redeemed event ticket is reserved by a non-premium member after making the at least one redeemed event ticket provided by the ticket holder available for reservation by another, prior to the event, providing the ticket package to the venue at which the corresponding event is scheduled to take place, and providing the ticket package to the non-premium member at the venue upon satisfactory identification of the non-premium member.

The method may further comprise preparing a ticket package including the at least one redeemed event ticket along with premium member benefits if the at least one redeemed event ticket is reserved by a premium member after making the at least one redeemed event ticket provided by the ticket holder available for reservation by another, prior to the event, providing the ticket package to the venue at which the corresponding event is scheduled to take place and providing ticket package documentation to the premium member from which the at least one redeemed event ticket may be printed, providing the ticket package including the at least one event ticket and the premium member benefits to the premium member at the venue upon satisfactory identification of the premium member if the premium member has not printed the at least one event ticket prior to the event, and providing only the premium member benefits to the premium member at the venue upon satisfactory identification of the premium member if the premium member has printed the at least one event ticket prior to the event.

The method may further comprise preparing a ticket package including only the at least one redeemed event ticket if the at least one redeemed event ticket is reserved by a non-premium member after making the at least one redeemed event ticket provided by the ticket holder available for reservation by another, prior to the event, providing the ticket package to the venue at which the corresponding event is scheduled to take place and providing ticket package documentation to the non-premium member from which the at least one redeemed event ticket may be printed, and providing the ticket package to the non-premium member at the venue upon satisfactory identification of the non-premium member if the non-premium member has not printed the at least one event ticket prior to the event.

The method may further comprise allowing members to conduct or request a search for one or more event tickets. The search conducted or requested by the member may include identification of a specific event type or league. Alternatively or additionally, the search conducted or requested by the member may include identification of a specific team. Alternatively or additionally, the search conducted or requested by the member may include identification of a specific opponent. Alternatively or additionally, the search conducted or requested by the member may include identification of a specific city in which the event corresponding to the one or more event tickets being searched is scheduled to take place. Alternatively or additionally, the search conducted or requested by the member may include identification of a specific venue in which the event corresponding to the one or more event tickets being searched is scheduled to take place. Alternatively or additionally, the search conducted or requested by the member may includes identification of a specific date or date range on which the event corresponding to the one or more event tickets being searched is scheduled to take place. Alternatively or additionally, the search conducted or requested by the member may include identification of a specific number of tickets. Alternatively or additionally, the search conducted or requested by the member may include identification of a specific grouping of seats. Alternatively or additionally, the search conducted or requested by the member may include identification of a specific section of seating in the venue. Alternatively or additionally, the search conducted or requested by the member may include identification of other products and/or services.

The method may further comprise providing the results of the search to the member.

The method may further comprise allowing the member to request an on-going search if the member does not select any of the results of the search.

The method may further comprise determining whether one or more tickets resulting from the search and selected by the member are readily available or need to be acquired. The method may further comprise soliciting ticket holder members for the one or more tickets resulting from the search and selected by the member if the one or more tickets resulting from the search and selected by the member are not readily available and need to be acquired. The method may further comprise purchasing the one or more tickets resulting from the search and selected by the member if the one or more tickets resulting from the search and selected by the member are not readily available after soliciting ticket holder members.

The method of claim 54 further comprise adding a first number of frequent user points to the member's account if the one or more tickets resulting from the search and selected by the member are readily available, the member is a premium member and the one or more tickets resulting from the search were selected by the premium member via a web site, and providing the tickets resulting from the search and selected by the premium member to the premium member. The method may further comprise adding a second number of frequent user points to the member's account if the one or more tickets resulting from the search and selected by the member are readily available, the member is a not a premium member and the one or more tickets resulting from the search were selected by the non-premium member via a web site, and providing the tickets resulting from the search and selected by the non-premium member to the non-premium member. The method may further comprise adding the second number of frequent user points to the member's account if the one or more tickets resulting from the search and selected by the member are readily available, the member is a premium member and the one or more tickets resulting from the search were not selected by the premium member via a web site, and providing the tickets resulting from the search and selected by the premium member to the premium member. The method may further comprise adding a third number of frequent user points to the member's account if the one or more tickets resulting from the search and selected by the member are readily available, the member is a non-premium member and the one or more tickets resulting from the search were not selected by the premium member via a web site, and providing the tickets resulting from the search and selected by the non-premium member to the non-premium member.

The method may further comprise allowing the member to issue a guest pass to another if the one or more tickets resulting from the search and selected by the member are readily available.

The method may further comprise deducting an appropriate number of points from the member's account or collecting cash payment for the one or more tickets if the one or more tickets resulting from the search and selected by the member are readily available, and providing ticket holder information to the team and/or venue hosting the event corresponding to the one or more tickets. The method may further comprise allowing cancellation of the reservation of the one or more tickets resulting from the search and selected by the member after being selected by the member. The method may further comprise determining a date difference as a difference between the date of the event corresponding to the one or more tickets reserved by the member and a date on which the reservation cancellation is requested, and refunding a first percentage of the final value of the one or more tickets being canceled if the date difference is greater than a first difference value. The method may further comprise refunding a second percentage of the final value of the one or more tickets being canceled if the date difference is less than the first difference value and greater than a second difference value. The method may further comprise refunding a third percentage of the final value of the one or more tickets being canceled if the date difference is less than the second difference value. The method may further comprise removing from the member's account any frequent user points resulting from the member's reservation of the one or more tickets being canceled. The method may further comprise providing information relating to the one or more tickets being canceled to the team and/or venue.

The method may further comprise offering to acquire the one or more tickets for face value on behalf of the member if the event or seat location corresponding to the one or more tickets resulting from the search and selected by the member need to be acquired and are not sold out. The method may further comprise determining whether to acquire the one or more tickets resulting from the search and selected by the member if the one or more tickets resulting from the search and selected by the member need to be acquired and are sold out. Determining whether to acquire the one or more tickets resulting from the search and selected by the member may comprise determining a point value, j, of the one or more tickets resulting from the search and selected by the member, determining an average market value, k, of the tickets resulting from the search and selected by the member, determining a minimum market value, m, of the tickets resulting from the search and selected by the member, establishing a ticket value premium threshold, n, offering to acquire the one or more tickets on behalf of the member for a price of m per ticket if k≦j*n, and declining to acquire the one or more tickets on behalf of the member if k>j*n.

The method may further comprise identifying the member's home league, identifying the league for which the search is being conducted, and limiting access by the member to only home league tickets resulting from the search if the member is a non-premium member. The method may further comprise allowing access by the member to a standard reservation time period for all leagues, sports and events if the league for which the search is being conducted is not the member's home league and the member is a premium member. The method may further comprise comparing opening day for the league for which the search is being conducted to the date of the search, and allowing access by the member to a home team reservation time period plus the standard reservation time period for all other leagues, sports and events if the league for which the search is being conducted is the member's home league, the member is a premium member and opening day for the league is greater than a first number of months away from the date of the search. The method may further comprise allowing access by the member to a home league reservation time period plus the standard reservation time period for all other leagues, sports and events if the league for which the search is being conducted is the member's home league, the member is a premium member and opening day for the league is greater than a second number of months away from the date of the search which is greater than the first number of months. The method may further comprise allowing access by the member to only the standard reservation time period for all leagues, sports and events if the league for which the search is being conducted is the member's home league, the member is a premium member but opening day for the league is less than the first number of months away from the date of the search.

A system comprising a processor for executing the any one or more of the foregoing methods. The system may further comprise a first database configured to store member account information therein. The system may further comprise a second database configured to store member point balance information therein. The system may further comprise a third database configured to store event ticket value and ownership information therein. The system may further comprise a fourth database configured to store event venue information therein. The system may further comprise a fifth database configured to store available event ticket information therein. The system may further comprise a sixth database configured to store other product information therein. The system may further comprise an interface between the system and a user accessing the system. The interface may comprise a web server. Alternatively or additionally, the interface may comprise a remote computer configured to access the web server. Alternatively or additionally, the interface may comprise a wireless device configured to access the web server. Alternatively or additionally, the interface may comprise a telephone. Alternatively or additionally, the interface may comprise a courier.

### BRIEF DESCRIPTION OF THE DRAWINGS

FIG. 1 is a block diagram of one illustrative embodiment of a system for exchanging event tickets.

FIG. 2 is a flow diagram of one illustrative process for exchanging event tickets.

FIG. 3 is a flowchart of one illustrative embodiment of the ticket holder validation process of FIG. 2.

FIG. 4 is a flowchart of one illustrative embodiment of the ticket selection and point assignment process of FIG. 2.

FIG. 5 is a flowchart of one illustrative embodiment of the ticket management process of FIG. 2.

FIG. 6 is a flowchart of one illustrative embodiment of the mail-based ticket fulfillment process of FIG. 2.

FIG. 7 is a flowchart of one illustrative embodiment of the venue-based ticket fulfillment process of FIG. 2.

FIG. 8 is a flowchart of one illustrative embodiment of the print-based ticket fulfillment process of FIG. 2.

FIG. 9 is a flowchart of one illustrative embodiment of the ticket valuation process of FIG. 2.

FIG. 10 is a flowchart of one illustrative embodiment of the ticket search process of FIG. 2.

FIG. 11 is a flowchart of one illustrative embodiment of the display ticket availability process of FIG. 2.

FIG. 12 is a flowchart of one illustrative embodiment of an evaluation for ticket acquisition process of FIG. 2.

FIG. 13 is a flowchart of one illustrative embodiment of the alternatives process of FIG. 2.

FIG. 14 is a flowchart of one illustrative embodiment of the reservation window process of FIG. 2.

FIG. 15 is a flowchart of one illustrative embodiment of the on-going search request process of FIG. 2.

FIG. 16 is a flowchart of one illustrative embodiment of the ticket reservation and frequent user process of FIG. 2.

FIG. 17 is a flowchart of one illustrative embodiment of the reservation cancellation process of FIG. 2.

FIG. 18 is a flowchart of one illustrative embodiment of the ticket packaging process of FIG. 2.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

The exemplary system and processes illustrated and described herein by way of example generally allow holders of tickets or admission rights (hereinafter “ticket holders” or ticket holders/members) to sporting, theatrical, musical, cultural and/or other types of events (hereinafter “events”) to exchange one or more tickets or admission rights directly for one or more tickets or admission rights to one or more other events of similar or different value and/or for other selected products and/or services. The exemplary system and processes illustrated and described herein carry this out in a general sense by assigning a value to the event tickets offered by the ticket holder according to a ticket valuation process, and then allowing that ticket holder to search for and select one or more available event tickets and/or other products and/or services based on the assigned value. The disclosed system and various processes also allow subscribers of the system (hereinafter “members”) to search for, and reserve event tickets and/or other products and/or services that are not, or not yet, available in the system database.

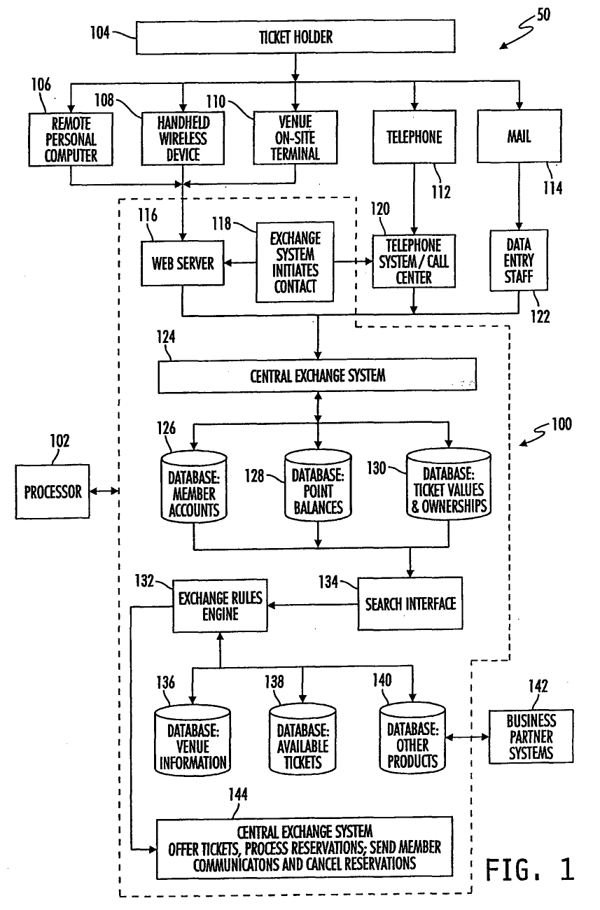

Referring now to FIG. 1, an overall system 50 for exchanging event tickets is shown. In the system 50, a ticket holder 104 may access a data processing system 100 via any one or more interfaces. The data processing system 100 is controlled by at least one conventional processor 102 configured to execute one or more software algorithms. Examples of several such software algorithms configured to control the exchange of event tickets are provided in the attached figures and will be described in detail hereinafter.

The ticket holder 104 may be the holder of any number of event tickets, and may or may not be a season ticket holder. In any case, the ticket holder 104 may access the data processing system 100 by logging into a web server 116 associated with the data processing system 100 via a conventional remote personal, laptop or notebook computer 106, handheld wireless device 108, such as a personal data assistant (PDA) web-enabled wireless telephone, or the like, venue on-site terminal 110, or the like. Alternatively or additionally, the ticket holder 104 may access the data processing system 100 by contacting a telephone system or call center 120 associated with the data processing system 100 via a conventional land-based or wireless telephone 112. Alternatively or additionally, the ticket holder 104 may access the data processing system 100 by contacting data entry staff 122 associated with the data processing system 100 via a mail-based interface 114 which may include, but should not be limited to, regular mail (e.g., U.S. Postal Service), courier and/or e-mail. In the illustrated embodiment, the data processing system 100 may also initiate contact with the ticket holder via a ticket holder contact interface 118 that directs the web server 116 and/or telephone system/call center 120 to make contact with the ticket holder in a conventional manner.

The web server 116, ticket holder contact interface 118, telephone system/call center 120 and data entry staff 122 interfaces with a number of databases, e.g., 126, 128, 130, within the data processing system 100 via a conventional central exchange system 124. These databases include, but are not limited to, a member accounts database 126 that contains information relating to ticket holders and their membership status, a point balances database 128 that contains information relating to currently available point balances for each member ticket holder, and a ticket ownership database 130 that contains information relating to valid tickets available for redemption by each member ticket holder and their assigned point values.

The databases 126, 128 and 130 each interface with a conventional exchange rules engine 132 via a conventional search interface 134. The exchange rules engine 132 also has direct access to another number of databases, e.g., 136, 138 and 140, and to another central exchange system 144. These databases include, but are not limited to, a venue information database 136 that contains information relating to various event venues, an available tickets database 138 that contains information relating to tickets available to be reserved in the system 50, and an other products database 140 that contains information relating to other products, services and/or incentives that may be offered to a ticket holder wishing to exchange one or more event tickets. The other products database 140 may be accessible to and by other business partner systems 142 that may provide any such other products, services and/or incentives and/or that may manage the availability of and reservations for such products, services and/or incentives.

Ticket holders submit event ticket exchange requests to the data processing system 100 via the search interface 134 to the exchange rules engine 132. The exchange rules engine 132 accesses data relating to event venues, tickets available to be reserved, and other available products from the databases 136, 138 and 140, and processes this information to offer tickets to members, process reservations, send member communications, and cancel reservations via the central exchange system 144.

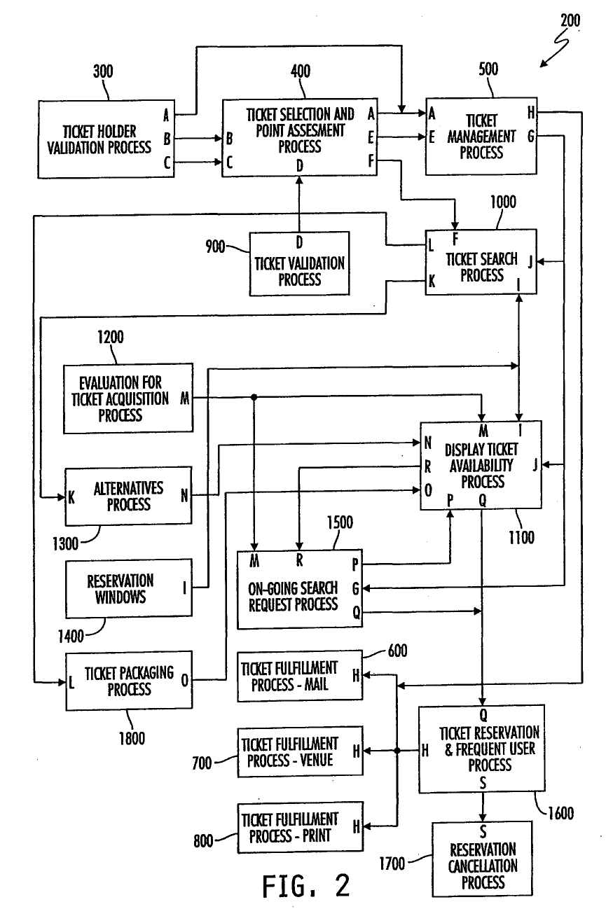

Referring now to FIG. 2, a flow diagram of one illustrative process 200 for exchanging event tickets is shown. The process 200 may be implemented, in whole or in part, in the form of one or more software algorithms stored in one or more of the databases of the data processing system 100 and executed by the at least one processor 102. The process 200 will be described as being carried out or executed by the data processing system 100, although it will be understood that the process 200 may, in practice, be carried out or executed in part by the data processing system 100 under the direction and control of the at least one processor 102, and in part by data processing personnel. In any case, the process 200 begins in this embodiment at a process block 300 once the ticket holder has accessed the data processing system 100 as described with respect to FIG. 1. At the process block 300, the data processing system 100 executes a ticket holder validation process that verifies the ticket holder's eligibility to use the event ticket exchange system 50, and requires the ticket holder to provide the physical ticket(s) to the data processing system 100. If eligible and the ticket holder's account is in good standing, the process 200 advances along paths “B” and “C” to a process block 400 where the data processing system 100 executes a ticket selection and point assignment process. In this process, the ticket holder may select tickets to redeem, and the data processing system 100 is operable to assign points to the ticket holder's account based on a predefined ticket valuation process at a process block 900. When the ticket(s) for redemption has/have been selected and point value(s) assigned at the process block 400, the process 200 advances along path “E” to a ticket management process block 500 and/or along path “F” to a ticket search process block 1000. If, in the process block 300 the data processing system 100 determines, when the ticket holder provides the physical ticket(s) to the data processing system 100, that the ticket holder's account is not in good standing, or if, in the process block 400 the data processing system 100 determines that event ticket(s) provided to the system 50 are not authentic, the process 200 proceeds along path “A” to the ticket management process 500.

In the ticket management process block 500, the data processing system 100 is operable to receive the redeemed ticket(s) from the ticket holder, verify the ticket(s) for authenticity, make the ticket(s) available for exchange and return the ticket(s) to the team or ticket holder as appropriate. If the redeemed and received ticket(s) is/are reserved by request of another member, the process 200 proceeds along path “H” to a mail-based ticket fulfillment process block 600, a venue-based ticket fulfillment process block 700 or a print-based ticket fulfillment process block 800. If, on the other hand, the ticket(s) is/are not reserved by another, the process 200 proceeds along path “G” to an on-going search request process block 1500.

The ticket selection and point assignment process block 400 is also configured to process requests by a ticket redeemer for one or more tickets to a different event. If so, the process 200 advances along path “F” to a ticket search process block 1000 where the data processing system 100 is operable to perform a search of available ones of the requested tickets and to then contact the ticket holder with the search results. The results of such a search, if requested by regular mail, are processed along path “J” via a display ticket availability process block 1100. The results of searches requested other than via regular mail are processed along path “K” by an alternatives process block 1300 and along path “L” by a ticket packaging process block 1800.

Ticket searching by the ticket search process block 100 may also be initiated by a reservation windows process block 1400 along path “I.” Such a ticket search request via path “I” also triggers operation of the display ticket availability process block 1100. Operation of the display ticket availability process block 1100, and operation of an on-going search request block 1500, is further triggered by operation of an evaluation for ticket acquisition process block 1200 along path “M.” Operation of the display ticket availability process block 1100 is further triggered by operation of the alternative process block 1300 along path “N,” by operation of the ticket packaging process block 1800 along path “O,” and by operation of the on-going search request process block 1500 along path “P.” If an on-going search is requested by a member, the display ticket availability process block 1100 triggers operation of the on-going search request process block via path “R.” Selection of one or more tickets and/or other products, services and/or incentives by a member via the display ticket availability process block 1100, and acceptance of one or more tickets by a member requesting an on-going search via the on-going search request process block 1500, trigger operation of a ticket reservation and frequent user process block 1600 via path “Q.” Successful ticket reservation via the ticket reservation and frequent user process block 1600 results in ticket fulfillment via the process blocks 600, 700 or 800 along path “H,” and cancellation of a ticket reservation directs the process 200 to a reservation cancellation process block 1700 along path “S.”

Once the ticket holder has accessed the data processing system 100, the ticket holder's eligibility to use the exchange system 50 is verified (process block 300). If eligible, the ticket holder then selects tickets to redeem and points are assigned to the ticket holder's account (process block 400). Point values are assigned based on input from the ticket valuation process (process block 900). Once tickets are redeemed, they must be received from the ticket holder, verified for authenticity, made available for exchange and returned to the ticket holder or the team/venue as necessary (process block 500). If the ticket holder submits an exchange request via the mail, a search is performed and the ticket holder contacted (process block 1000). Otherwise, the ticket holder selects values from a series of search parameters and submits the search request (process block 1000). The data processing system 100 then delivers tickets available for reservation to the ticket holder who can select available tickets to reserve, elect to wait list for tickets that are not currently available (process block 1500), or do nothing (process block 1100). Input to the display ticket availability process block 1100 is provided by operation of the evaluation for ticket acquisition process block 1200, which uses market pricing data to determine if under-supplied tickets will be acquired to satisfy exchange requests, the alternatives process block 1300, which identifies tickets not requested but possible to also satisfy a particular exchange request, the reservation windows process block 1400, which plays a role in defining which tickets may be accessed by any particular exchange request, and the ticket packaging process block 1800, which gives the ticket holder the opportunity to add other products that are not part of the exchange system 50 to the exchange request. If tickets are selected for reservation, points and/or cash are removed from the ticket holder's account and frequent user points are added to the ticket holder's account (process block 1600). Tickets are delivered to the ticket holder via regular mail (process block 600), made available at the event venue on the day of the event (process block 700), or provided to the requestor in the form of an electronically printable certificate at home or at the event venue on the day of the event (process block 800). If the ticket holder ultimately cancels the reservation, this information is processed by the reservation cancellation process block 1700.

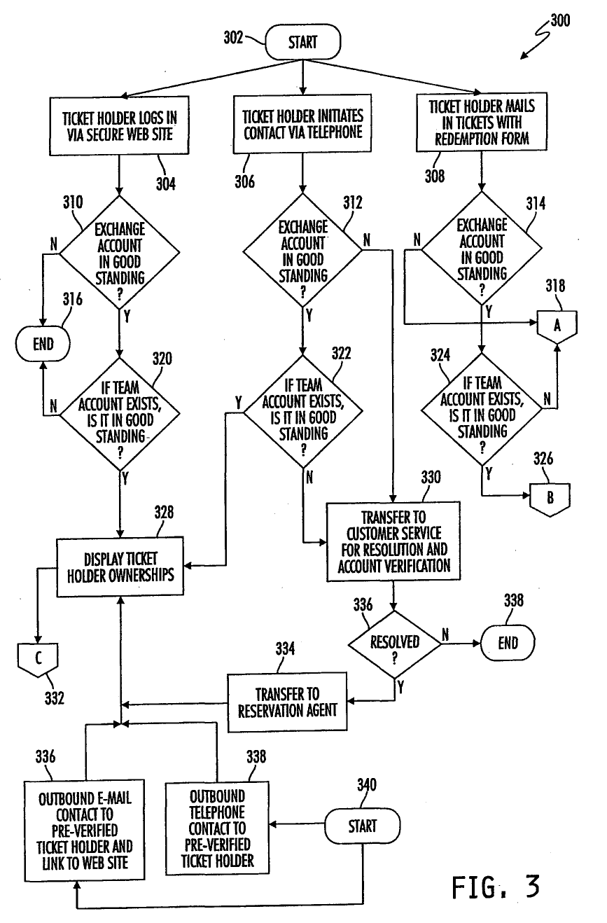

Referring now to FIG. 3, a flowchart of one illustrative embodiment of the ticket holder validation process block 300 of FIG. 2 is shown. In the illustrated embodiment, the process 300 begins at step 302 and thereafter advances in parallel to steps 304, 306 and 308 where the ticket holder accesses the data processing system 100. At step 304, for example, the ticket holder may access the data processing system 100 of the event ticket exchange system 50 by logging into a secure web site managed and controlled by the data processing system 100. Alternatively or additionally, the ticket holder may access the data processing system 100 at step 306 by initiating contact with a call center forming part of the system 50. Alternatively or additionally still, the ticket holder may access the data processing system 100 at step 308 by mailing in one or more tickets that the ticket holder wished to redeem, along with a redemption form that the ticket holder has completed. After each such access attempt, the process 300 determines whether the ticket holder's exchange account is in good standing (steps 310, 312 and 314).

If the ticket holder initiated contact via a secure web site and their account is not in good standing, the process 300 advances from the “NO” branch of step 310 to step 316 where the session ends. Otherwise, the process 300 advances from the “YES” branch of step 310 to step 320 where the process 300 determines the status of the ticket holder's team account, and, if the ticket holder has one or more team accounts, whether it/they are in good standing. If not, the process 300 advances to step 316 where the session ends. If, at step 320, the process 300 determines that the one or more team accounts of the ticket holder is/are in good standing, the process 300 advances to step 328 where the data processing system 100 displays on the ticket holder's computer 106 or wireless device 108 details relating to the ticket holder's account ownerships on record. Thereafter, the process 300 advances to the process block 400 along path “C.”

If the ticket holder initiated contact with the data processing system 100 via telephone and their account is not in good standing, the process 300 advances from the “NO” branch of step 312 to step 324 where the process 300 transfers the call to a customer service representative for resolution of issues and/or verification of accounts. Otherwise, the process 300 advances from the “YES” branch of step 312 to step 322 where the process 300 determines the status of the ticket holder's team account, and, if the ticket holder has one or more team accounts, whether it/they are in good standing. If so, the process 300 advances to step 328 where the data processing system 100 displays to a customer service representative details relating to the ticket holder's account ownerships on record. Thereafter, the process 300 advances to the process block 400 along path “C.” If, at step 322, the process 300 determines that the one or more team accounts of the ticket holder is/are not in good standing, the process 300 advances to step 324 for resolution of issues and/or verification of accounts. Thereafter at step 336, the process 300 determines whether all issues have been resolved. If not, the process 300 advances to step 338 where the session ends. If, at step 336, the process 300 determines that all issues have been resolved, the process 300 advances to step 334 where the call is transferred to a reservation agent. Thereafter the process 300 advances to step 328 where the data processing system 100 displays to a customer service representative details relating to the ticket holder's account ownerships on record. Thereafter, the process 300 advances to the process block 400 along path “C.”

If the ticket holder initiated contact with the data processing system 100 via regular mail and their account is not in good standing, the process 300 advances from the “NO” branch of step 314 to the ticket management process block 500 via path “A.” Otherwise, the process 300 advances from the “YES” branch of step 314 to step 324 where the process 300 determines the status of the ticket holder's team account, and, if the ticket holder has one or more team accounts, whether it/they are in good standing. If so, the process 300 advances to the ticket selection and point assignment process block step 400 along path “B.” Otherwise, the process 300 advances from the “NO” branch of step 324 to the ticket management process block 550 along path “A.”

In the embodiment of the process 300 illustrated in FIG. 3, the data processing system 100 may initiate contact with a member. This process begins at step 340 and advances in parallel to steps 336 and 338. To contact a member via outbound e-mail, the process 300 advances from step 340 to step 336 where the data processing system 100 initiates an outbound e-mail to a pre-verified ticket holder/member, along with a link to the secure web site managed and controlled by the data processing system 100. From step 336, the process 300 advances to step 328 where the data processing system 100 displays on the ticket holder's/member's computer 106 or wireless device 108 details relating to the ticket holder's account ownerships on record. To contact a member via telephone, the process 300 advances from step 340 to step 338 where the data processing system 100 initiates a telephone call to the pre-verified ticket holder/member. From step 338, the process 300 advances to step 328 where the data processing system 100 displays to a customer service representative details relating to the ticket holder's account ownerships on record. Thereafter, the process 300 advances to the process block 400 along path “C.”

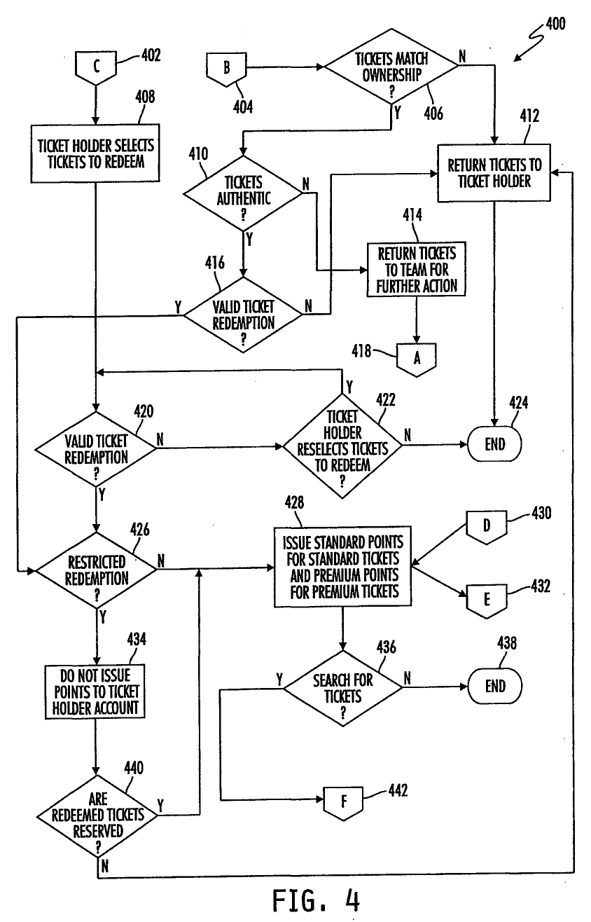

Referring now to FIG. 4, a flowchart of one illustrative embodiment of the ticket selection and point assignment process block 400 of FIG. 2 is shown. In the illustrated embodiment, the process 400 is accessed from the ticket holder validation process block 300 along path “C” at step 402, and thereafter at step 408 the ticket holder accessing the data processing system 100 via the web or telephone selects one or more tickets from a list of tickets in the ticket holder's account (or accounts) to be redeemed for points. Generally, the ticket ownership database 130 will have the ticket ownership information for members stored therein, and at step 408 the data processing system 100 will be operable to display ticket information for any ticket that a ticket holder/member owns that is available for exchange. Thereafter the process 400 advances to step 420 where the process 400 determines whether the one or combination of tickets being redeemed by the ticket holder for points is valid. If not, the process 400 advances to step 422 where the ticket holder may reselect one or a combination of tickets to be redeemed. If the ticket holder chooses not to reselect tickets, the process 400 advances to step 424 where the session is ended. Otherwise, the process 400 loops back to step 420 for validation of the one or combination of tickets selected by the ticket holder at step 422.

If, at step 420, it is determined that the one or combination of tickets selected by the ticket holder for redemption is/are valid, the process 400 proceeds to step 426 where the ticket holder may designate the one or combination of selected tickets as being restricted or unrestricted. If the ticket holder designates the one or combination of selected tickets as being unrestricted, the process 400 advances to step 428 where the data processing system 100 assigns a point value or point values, corresponding to a predefined valuation of the ticket or tickets that is carried out in the ticket valuation process block 900 and provided to the process 400 via the path “D,” to the ticket holder's account. Such a point value or point values may be or include different point types for differently designated tickets. For example, in the embodiment illustrated in FIG. 4, the point value or point values may be or include standard points for standard tickets and premium points for premium tickets. Those skilled in the art will recognize that step 428 may include any number of different point types for corresponding ones of differently designated tickets, and that the two different point and ticket types illustrated in FIG. 4 should not be considered to be limiting in any way. From step 428, the process 400 advances to the ticket management process block 500 along path “E.” If, at step 422, the ticket holder designates the one or combination of selected tickets as being restricted, the process 400 advances to step 434 where the points that would otherwise be assigned to the ticket holder's account are held by the data processing system 100 until the tickets redeemed for those points have been reserved by another ticket holder. Generally, a ticket holder may designate tickets as being restricted for one or more personal or other reasons. As one example, which should not be considered to be limiting in any way, a ticket holder may base a restriction on the requirement that the redeemed ticket or tickets must be subsequently be reserved by a member who owns tickets for the same team. Other reasons for designating redeemed tickets as being restricted will occur to those skilled in the art, and any such other reasons are contemplated by this disclosure. Illustratively, the ticket restriction process may be implemented in the form of a list of possible restrictions that the ticket holder member may choose from. Alternatively, the ticket restriction process may allow for member definition of restrictions. In any case, step 434 advances to step 440 where the data processing system 100 determines whether the redeemed ticket or tickets designated as being restricted have been reserved by another ticket holder. If not, the process 400 loops back to step 412. When the redeemed ticket or tickets designated as being restricted have been reserved by another ticket holder, step 440 advances to step 428 where the data processing system 100 assigns a point value or point values, corresponding to a predefined valuation and event demand level of the ticket or tickets that is carried out in the ticket valuation process block 900 and provided to the process 400 via the path “D,” to the ticket holder's account. From step 428, the process 400 advances to the ticket management process block 500 along path “E.”

Once points have been assigned to the ticket holder's account, the ticket holder may then use the assigned points to search for available tickets in the database of available tickets 138 (e.g., tickets redeemed by other ticket holders/members). Thus, following step 428, the process 400 also advances to step 436 where the ticket holder that has just redeemed one or more tickets for points is prompted to indicate whether the ticket holder desires to search for any available tickets. If so, the process 400 advances to the ticket search process block 1000 along path “F.” If not, the process 400 advances to step 438 where the session is ended.

In the illustrated embodiment, the process 400 is also accessed from the ticket holder validation process block 300 along path “B” at step 404, and thereafter at step 406 the ticket or tickets provided to the data processing system 100 by the ticket holder via regular mail is/are checked against information in the ticket ownership database 130 to determine whether they are indeed owned by the ticket holder/member designated on the redemption form accompanying the mailed ticket or tickets. If not, the ticket or tickets are returned to the ticket holder at step 412 and the session thereafter ends at step 424. If, at step 406 it is determined that the mailed ticket or tickets are owned by the ticket holder/member designated on the redemption form accompanying the mailed ticket or tickets, the process advances to step 410 where the data processing system 100 checks the mailed ticket or tickets to determine whether they are authentic (e.g., not a forgery). If the ticket or tickets cannot be authenticated at step 410, the process 400 advances to step 414 where the non-authentic ticket or tickets are returned to the team or other ticket issuing authority for further action that the team or authority deems appropriate. Thereafter, the process 400 advances to the ticket management process block 500 along path “A.”

If, at step 410 the mailed tickets are determined to be authentic, the process 400 advances to step 416 where the data processing system 100 checks to determine whether, if multiple tickets have been mailed, they form a valid combination. For example, if a pair of mailed tickets is designated on the ticket redemption form as being side-by-side seats for the same event, yet the tickets received in the mailing are for two different events, this combination is not valid. Other examples of invalid combinations will occur to those skilled in the art, and any such other invalid combinations are contemplated by this disclosure. In any case, if it is determined at step 416 that multiple tickets do not form a valid combination, the process 400 advances to step 412 where the ticket or tickets are returned to the ticket holder and the session thereafter ends at step 424. If it is otherwise determined at step 416 that multiple tickets do form a valid combination, the process 400 advances to step 426 to allow the ticket holder to designate the tickets as restricted or unrestricted as described hereinabove.

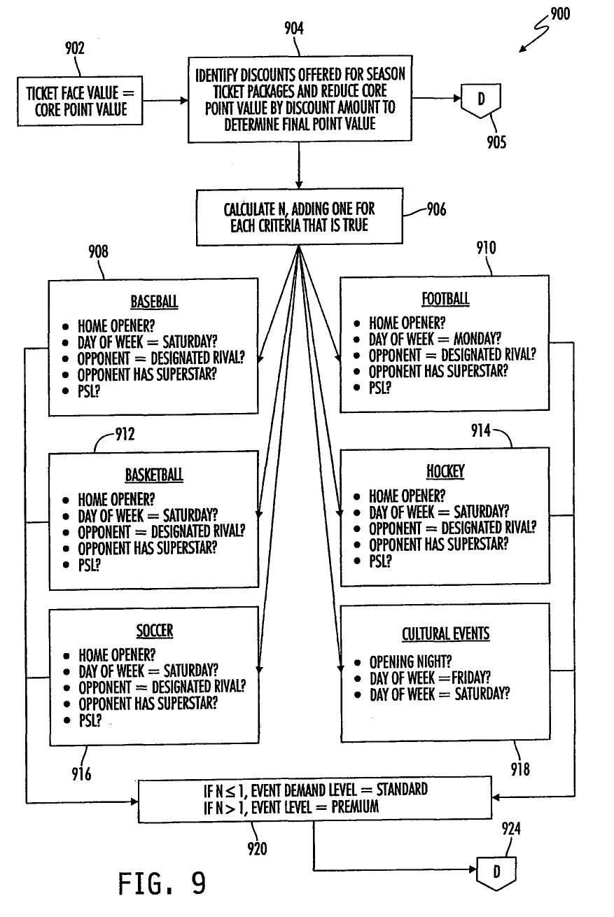

Referring now to FIG. 9, a flowchart of one illustrative embodiment of the ticket valuation process block 900 of FIG. 2 is shown. In the illustrated embodiment, the process 900 begins at step 902 where the data processing system 100 sets a core point value equal to the face value of the event ticket. Thereafter at step 904, the data processing system 100 identifies any discounts that are offered to purchasers of season ticket packages, and then reduces the core point value of step 902 by a corresponding discount amount to determine a final point value. Thereafter at step 905, the final point value is provided to the ticket selection and point assignment process block 400 along path “D.”

Step 904 also advances to step 906 where event type-specific criteria are evaluated and positive outcomes are counted to determine a demand level that is assigned to each individual event within each event type. All positive outcomes of the criteria comparisons evaluated at step 906 are accumulated via a counter, “n.” These criteria may be different for different types of events, although one or more criterion may be common across all event types. Examples of some criteria for five different sporting event types and one cultural event type are illustrated in block 908-918. For sporting events, for example, criteria may include whether the game in question is a home opener, whether the game will be played on a desirable day of the week and/or at a desirable time, e.g., Saturday afternoon, Monday night, etc., whether the opponent is a designated rival, whether one or more of the players on the opponent's team is a well-known superstar, etc. For cultural events, for example, criteria may include whether the event is opening night, whether the event is scheduled for a particular day of the week and/or at a desirable time, e.g., Friday or Saturday night, etc. Those skilled in the art will recognize other or alternative positive criteria that may be used to assess the desirability of attending the event corresponding to the ticket being evaluated, and any such other or alternative criteria are contemplated by this disclosure.

In any case, the process 900 advances from step 906 to step 920 via one or more of the steps 908-918 where the criteria count value, “n,” is evaluated to determine a corresponding demand level for the ticket under evaluation. In the illustrated embodiment, step 920 is generally carried out by comparing “n” to a predefined value, and then assigning the demand level based on this comparison. In the illustrated embodiment, for example, the predefined comparison value is 1, and if n is less than or equal to 1 at step 920, the demand level is “Standard,” and if n is otherwise greater than 1, the demand level is “Premium.” It will be understood that n may alternatively be set to any positive integer value, and that the example illustrated in FIG. 9 should therefore not be considered to be limiting in any way. In any case, the process 900 advances from step 920 to step 924 where the ticket demand level is provided to the ticket selection and point assignment process block 400 along path “D.” It will be understood that the specific ticket valuation and demand level determination processes illustrated in FIG. 9 are provided only by way of example, and should not be considered to be limiting in any way.

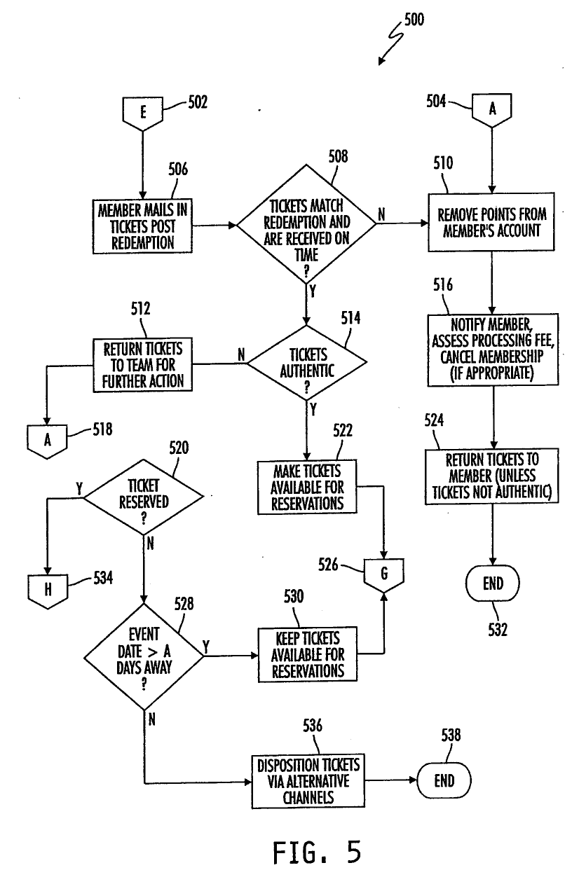

Referring now to FIG. 5, a flowchart of one illustrative embodiment of the ticket management process block 500 of FIG. 2 is shown. In the illustrated embodiment, the process 500 is accessed from the ticket selection and point assignment process block 400 along path “E,” and thereafter at step 506 the data processing system 100 receives one or more event tickets mailed by a ticket holder/member after points have been added to the ticket holder/member's account. Thereafter at step 508, the data processing system 100 compares the received ticket or tickets with information regarding the previously redeemed tickets to determine whether the received ticket or tickets match those previously redeemed and to also determine whether the ticket or tickets have been received by the data processing system 100 within sufficient time subsequent to redemption to perform ticket validation. In any case, if it is determined at step 508 that the received ticket or tickets do not match that/those previously redeemed or it is determined that the received ticket or tickets were not received within sufficient time subsequent to redemption, the process 500 advances to step 510 where the points that were assigned to the ticket holder's account for the redeemed tickets are removed. Step 510 is also executed when the process 500 is accessed from the ticket holder validation process block 300 along path “A.” In either case, the process 500 advances from step 510 where the points that were assigned to the ticket holder's account for the redeemed tickets are removed, to step 516 where the data processing system 100 notifies the ticket holder/member that their mailed in tickets could not be processed, assesses a ticket processing fee to the ticket holder's/member's account and, if the ticket or tickets were determined at step 404 of the process 400 or at step 514 of the process 500 to be non-authentic, cancels the ticket holder's/member's account. Thereafter at step 524, the ticket or tickets are returned to the ticket holder/member, unless the ticket or tickets were determined at step 404 of the process 400 or at step 514 of the process 500 to be non-authentic, in which case the ticket or tickets are returned to the team or other ticket issuing authority. Following step 524, the session is terminated at step 532.

If it is determined at step 508 that the received ticket or tickets match that/those listed on the accompanying ticket redemption form and it is also determined that the received ticket or tickets were received within sufficient time subsequent to redemption, the process 500 advances to step 514 where the ticket or tickets is/are checked for authenticity. If it/they are determined to be non-authentic, the process 500 advances to step 512 where the ticket or tickets is/are returned to the team or other ticket issuing authority for further action that the team or other ticket issuing authority deems appropriate. Thereafter, the process advances, via steps 518 and 504, to step 510.

If, at step 514, it is determined that the received ticket or tickets is/are authentic, the process 500 advances to step 522 where the redeemed ticket or tickets is/are made available in the data processing system 100 for reservation by other ticket holders/members. Generally, step 522 is carried out in the data processing system 100 by storing information relating to the redeemed ticket or tickets in the available tickets database 138 so that other ticket holders/members can subsequently search for and reserve the ticket or tickets. In any case, the process 500 advances from step 522 to the on-going search request process block 1100 of FIG. 2 along path “G.”

The ticket management process block 500 is further configured to periodically evaluate the database of available tickets 138 to determine the reservation status of the ticket information stored therein and to act on unreserved tickets at some point in time as the scheduled event approaches. Illustratively, this evaluation may take place once per day, although this disclosure contemplates conducting this evaluation more or less often. In any case, this process begins at step 520 where the data processing system 100 periodically and automatically evaluates information relating to each ticket stored in the database of available tickets to determine reservation status of each available ticket. For any ticket that has been reserved but has not yet been provided to the ticket reserving member, the process 500 advances to the ticket fulfillment process blocks 600, 700 and 800 of FIG. 2 along the path “H.” For any ticket in the database of available tickets 138 that has not yet been reserved, the process advances from step 520 to step 526 to determine if the event for any such ticket is scheduled to take place more than a predetermined number, “a,” of days away. If so, the process 500 advances to step 530 where the information relating to any such ticket is maintained in the database of available tickets for reservation by another member. If, on the other hand, it is determined at step 528 that the event for any unreserved ticket is scheduled to take place in less than or equal to the predetermined number, “a,” of days, the process 500 advances to step 536 where the tickets are disposed of via alternate channels. Examples of such alternate channels include, but are not limited to, return of the ticket or tickets to the team or other ticket issuing authority to do with what they wish. Thereafter at step 538 the process 500 terminates.

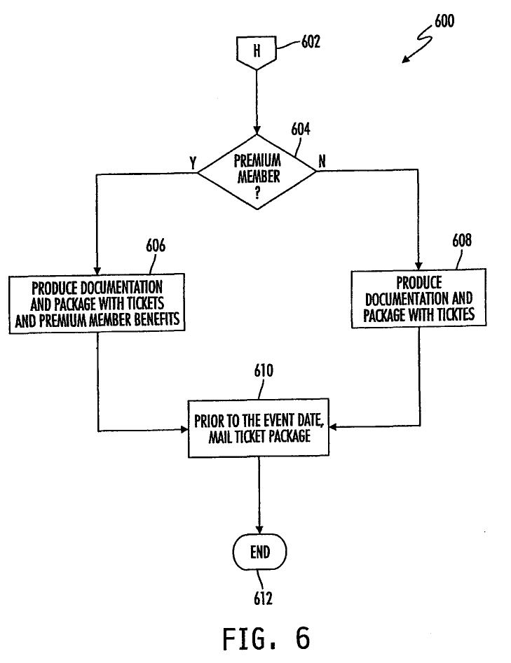

Referring now to FIG. 6, a flowchart of one illustrative embodiment of the mail-based ticket fulfillment process block 600 of FIG. 2 is shown. In the illustrated embodiment, the process 600 is accessed from the ticket management process block 500 and from the ticket reservation and frequent user process block 1600 along path “H” (step 602), and thereafter at step 604 it is determined whether the ticket reserving member is a premium member. Illustratively, the data processing system 100 is configured to execute step 604 by accessing the member's member account information stored in the member account database 126. If the ticket reserving member is a premium member, the process 600 advances to step 606 where the data processing system 100 produces documentation and a ticket package including the reserved ticket or tickets and one or more premium member benefits and/or incentives. Otherwise, the process 600 advances from step 604 to step 608 where the data processing system 100 produces documentation and a ticket package including only the reserved ticket or tickets. Following either of steps 606 and 608, the process 600 advances to step 610 where, prior to the event date, the ticket package is mailed to the ticket reserving member via regular mail, courier or the like. It will be understood that the one or more premium member benefits and/or incentives may be or include any one or more products and/or services, vouchers for any one or more products or services, or the like.

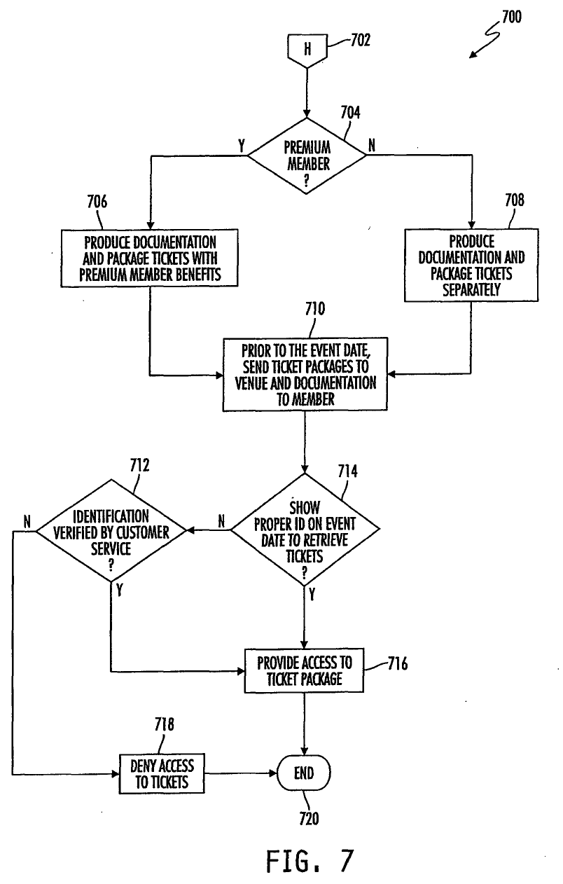

Referring now to FIG. 7, a flowchart of one illustrative embodiment of the venue-based ticket fulfillment process block 700 of FIG. 2 is shown. In the illustrated embodiment, the process 700 is accessed from the ticket management process block 500 and from the ticket reservation and frequent user process block 1600 along path “H” (step 702), and thereafter at step 704 it is determined whether the ticket reserving member is a premium member. If the ticket reserving member is a premium member, the process 700 advances to step 706 where the data processing system 100 produces documentation and a ticket package including the reserved ticket or tickets and one or more premium member benefits and/or incentives. Otherwise, the process 700 advances from step 704 to step 708 where the data processing system 100 produces documentation and a ticket package including only the reserved ticket or tickets. Following either of steps 706 and 708, the process 700 advances to step 710 where, prior to the event date, the ticket package is provided to the venue, e.g., to the will-call service of the venue, and the documentation is mailed or otherwise provided to the member. Thereafter at step 714, when the ticket reserving member reaches the venue on the day of the event, the reserving member may be required to present identification to gain possession of the reserved ticket or tickets. If so, the customer service personnel at the venue will, upon verification of the identification of the ticket reserving member, provide the ticket package to the ticket reserving member at step 716. If, at step 714 the ticket reserving member is not required to present identification, or the ticket reserving member cannot for some reason produce a valid identification, the process 700 advances to step 712 where the customer service personnel at the venue may attempt to verify the identification of the ticket reserving member through some other process. If this is successful, the process 700 advances to step 716. If not, the process 700 advances to step 718 where access to the reserved ticket package is denied. From steps 716 and 718, the process terminates at step 720.

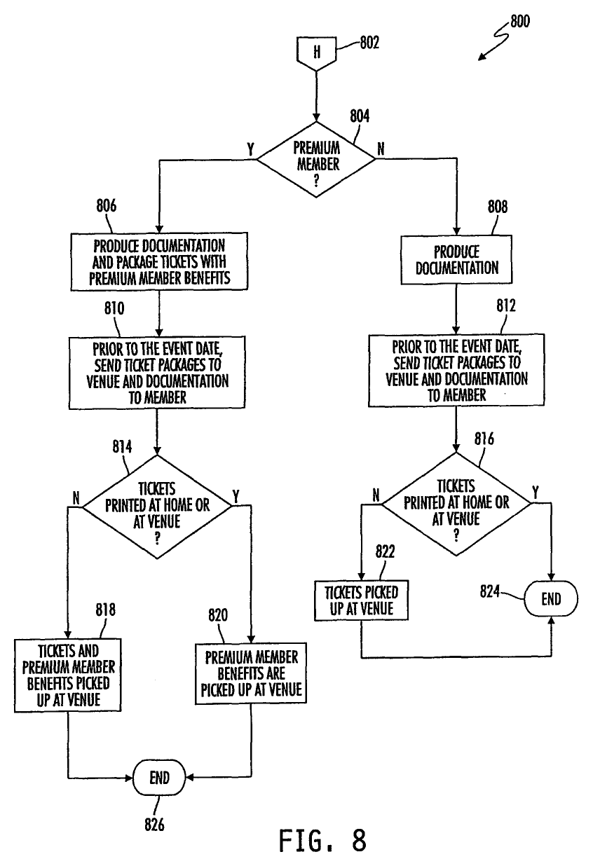

Referring now to FIG. 8, a flowchart of one illustrative embodiment of the print-based ticket fulfillment process block 800 of FIG. 2 is shown. In the illustrated embodiment, the process 800 is accessed from the ticket management process block 500 and from the ticket reservation and frequent user process block 1600 along path “H” (step 802), and thereafter at step 804 it is determined whether the ticket reserving member is a premium member. If the ticket reserving member is a premium member, the process 800 advances to step 806 where the data processing system 100 produces documentation and a ticket package including the reserved ticket or tickets and one or more premium member benefits and/or incentives. Thereafter at step 810 the ticket package is provided to the venue prior to the event date, and the documentation is mailed or otherwise provided to the member. Thereafter at step 814, the ticket reserving member has the option of printing the reserved ticket or tickets. If the ticket reserving member elects not to print the reserved ticket or tickets, the process 800 advances to step 818 where the ticket reserving member picks up the ticket package and premium member benefits and/or incentives from the venue on the day of the event. If, at step 814, the ticket reserving member elects to print the ticket or tickets, the process 800 advances to step 820 where the ticket reserving member may pick up the premium member benefits and/or incentives from the venue on the day of the event. The process 800 terminates at step 826 following steps 818 and 820.

If it is determined at step 804 that the ticket reserving member is not a premium member, the process 800 advances to step 808 where the data processing system 100 produces documentation relating to the reserved ticket or tickets. Thereafter at step 812, the ticket package including only the reserved ticket or tickets is provided to the venue prior to the event date, and the documentation is mailed or otherwise provided to the member. Thereafter at step 816, the ticket reserving member has the option of printing the reserved ticket or tickets. If the ticket reserving member elects not to print the reserved ticket or tickets, the process 800 advances to step 822 where the ticket reserving member picks up the ticket package containing the reserved ticket or tickets at the venue on the day of the event. If, at step 816, the ticket reserving member elects to print the ticket or tickets, ticket reserving member need not retrieve anything from the venue, and instead may proceed directly to the gate of the venue with the pre-printed ticket or tickets on the day of the event. The process 800 terminates at step 824 following step 822 and following the “Yes” branch of step 816. Illustratively, the process illustrated in steps 714-718 may be used to control receipt by the ticket reserving member of the ticket package and/or premium member benefits and/or incentives from the venue.

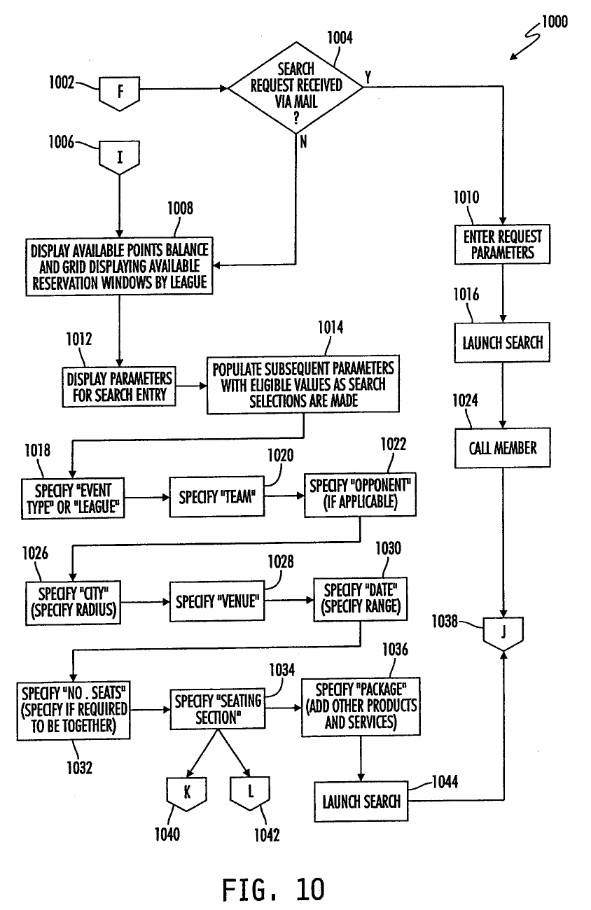

Referring now to FIG. 10, a flowchart of one illustrative embodiment of the ticket search process block 1000 of FIG. 2 is shown. In the illustrated embodiment, the process 1000 is accessed from the ticket selection and point assignment process block 400 along path “F” (step 1002), and thereafter at step 1004 it is determined whether the ticket search request was received by mail. If so, the process 1000 advances to step 1010 where the ticket request parameters specified by the member requesting the ticket search are entered into the data processing system 100. Such parameters may include, for example, but are not limited to, event type, event date, team or teams participating in the event, seat location, number of available seats in blocks of available seats, day of the week, time of day, etc. Thereafter at step 1016, the data processing system 100 conducts the search, and thereafter at step 1024 the member is contacted with the results of the ticket search. The process 1000 advances from step 1024 to step 1038 where the process 1000 is directed to the display ticket availability process block 1100 along path “J.”

If, at step 1004, it is determined that the ticket search request was received via some way other than by mail, the process 900 advances to step 1008 where the data processing system 100 displays, such as via the member's computer 106 or wireless device 108, or via an on-site terminal 110, the member's available point balance along with available reservation windows partitioned by league or event type. Step 1008 is also accessed from the display ticket availability process block 1100 along path “I” (step 1006). In any case, following step 1008 the process 1000 advances to step 1012 where the data processing system 100 displays to the member available parameters for ticket searching. Thereafter at step 1014, as the member selects the displayed search parameters, the data processing system 100 responds by populating the search parameters with eligible search values. Steps 1018-1034 illustrate example search parameters that the member may be asked by the data processing system 100 to specify for any particular ticket search. For example, the member may be asked to specify at step 1018 a particular event type or league, specify at step 1020 a particular team, specify at step 1022 a particular opponent that the specified team is scheduled to play, specify at step 1026 a particular city in which the event is scheduled, specify at step 1028 a particular venue at which the event is scheduled, specify at step 1030 a particular date or date range for which the event is scheduled, specify at step 1032 a number of seats desired, and whether the number of seats must be together (e.g., in a block or row), and/or specify at step 1034 a particular seating section of the venue. Those skilled in the art will recognize other search criteria, and the ticket search process 1000 may accordingly include any such other search criteria and/or more or fewer of the search criteria illustrated in FIG. 10. In any case, the process 1000 advances from step 1034 to step 1040 where the process 1000 directs search data to the alternatives process block 1300 along path “K,” and to step 1042 where the process 1000 directs search data to the ticket packaging process block 1800 along path “L.” Step 1034 also advances to step 1036 where the member requesting the ticket search may also specify a “package” to include other available products and/or services as part of the overall ticket package. From step 1036, the process 1000 advances to step 1044 where the data processing system 100 launches the search based on the search parameters specified by the member requesting the ticket search. From step 1044, the process 1000 advances to step 1038 where the process 1000 is directed to the display ticket availability process block 1100 along path “J.”

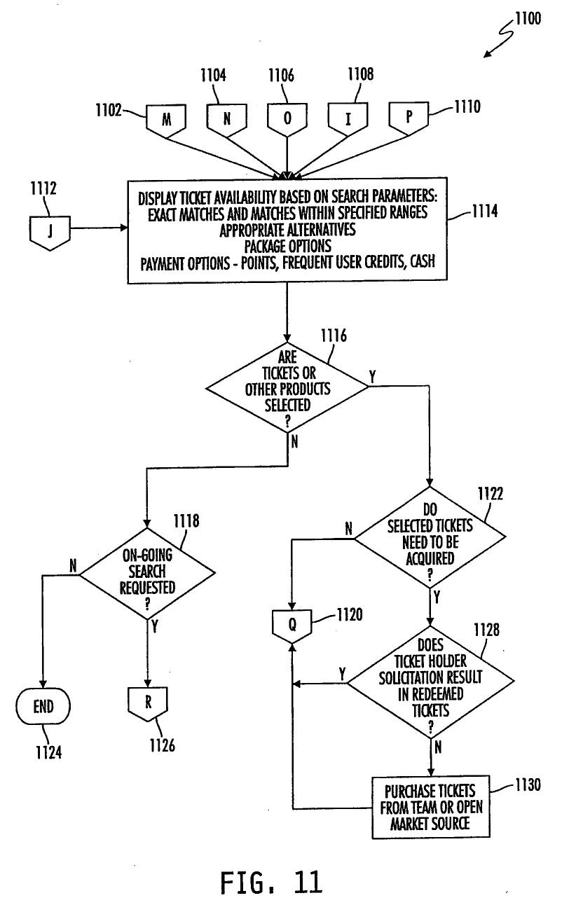

Referring now to FIG. 11, a flowchart of one illustrative embodiment of the display ticket availability process block 1100 of FIG. 2 is shown. In the illustrated embodiment, the process 1100 is accessed from the ticket evaluation for acquisition process block 1200 along path “M” (step 1102), from the alternatives process block 1300 along path “N” (step 1104), from the ticket packaging process block 1800 along path “O” (step 1106), from the reservation windows processing block 1400 along path “I” (step 1108), from the on-going search request process block 1500 along path “P” (step 1110) and from the ticket search process block 1000 along path “J” (step 1112). Thereafter at step 1114 the data processing system 100 displays ticket availability based on the search parameters entered according to the ticket search request. This display of available reservation options may include, but are not limited to, any one or more of exact matches and matches within specified ranges based on search criteria, system-generated alternatives, ticket package options and payment options including, but not limited to, accumulated points, frequent user credits and/or cash payment. The member may then select tickets and/or other products for reservation, and at step 1116 the data processing system 100 determines whether the member has made any such selections. If not, the process 1100 advances to step 1118 where the data processing system 100 determines whether an on-going search has been requested by the member. If not, the session ends at step 1124, but if an on-going search has been requested the process 1100 advances to the on-going search request process block 1500 along path “R” (step 1126).

If, at step 1116, the data processing system 100 determines that the member has selected a ticket or tickets and/or other products, the process 1100 advances to step 1122 where the data processing system 100 determines whether the selected ticket or tickets and/or other products exist in the database of available tickets 138 and/or the database of other products 140, or whether the selected ticket or tickets and/or other products need to be acquired by the system 100. If the selected ticket or tickets and/or other products need to be acquired, the process 1100 advances to step 1128 where the data processing system 100 solicits ticket holders/members that own such tickets and then determines whether the ticket holder solicitation resulted in redemption of the selected ticket or tickets and/or other products. If not, the process 1100 advances to step 1130 where the system 100 acquires the selected ticket or tickets and/or other products via purchase from a team or other open market source. From step 1130, the “Yes” branch of step 1128 and the “No” branch of step 1122, the process 1100 advances to the ticket reservation and frequent user process block 1600 along path “Q” (step 1120).

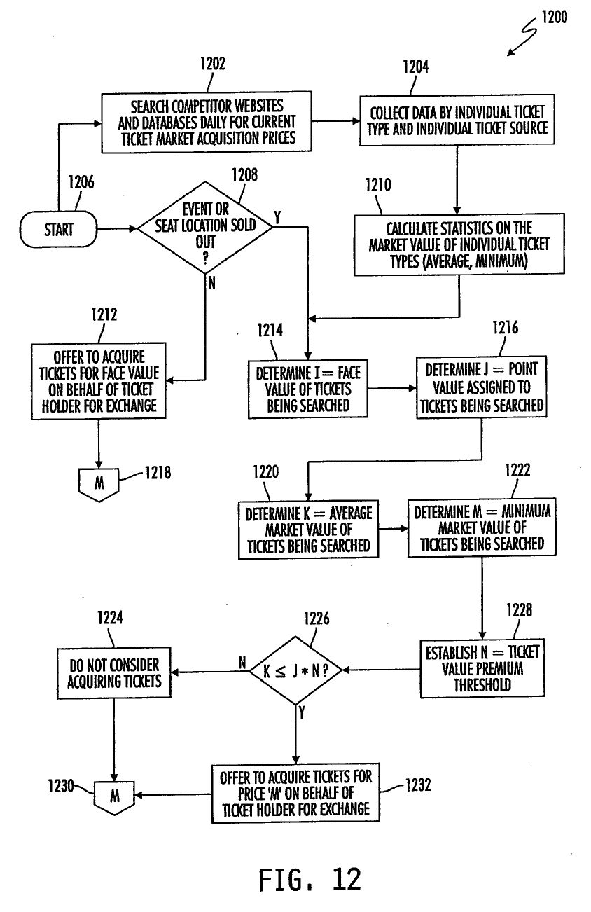

Referring now to FIG. 12, a flowchart of one illustrative embodiment of the evaluation for ticket acquisition process block 1200 of FIG. 2 is shown. When requested tickets are not available in the database of available tickets 138 and/or requested products are not available in the database of available products 140, an evaluation is performed according to the process bock 1200 to determine if the cash acquisition price for the requested tickets and/or products is within acceptable thresholds and therefore will be purchased by the system 100 and used to satisfy the member's ticket and/or product request. In the illustrated embodiment, the process 1200 begins at step 1206, and thereafter at step 1202 the data processing system 100 periodically, e.g., daily, searches competitor websites and or other databases for current ticket market acquisition prices. Thereafter at step 1204, the data processing system collects data by individual ticket type and individual ticket source. Thereafter at step 1210, the data processing system 100 computes statistics relating to the market value of the individual ticket types, e.g., minimums, maximums, averages, etc.

The start step 1206 of the process block 1200 also advances to step 1208 where the data processing system 100 determines whether the event or seat location for which the ticket or tickets and/or other products is sold out. If not, the process 1200 advances to step 1212 where the data processing system 100 offers to acquire the ticket or tickets and/or other products for face value on behalf of the member, and the process 1200 thereafter advances to the display ticket availability process block 1100 along path “M” (step 1218).

From step 1210, and from the “Yes” branch of step 1208, the process 1200 advances to step 1214 where the data processing system 100 determines the face value, “i,” of the ticket(s) or other product(s) being searched, then to step 1216 where the data processing system 100 determines a point value, “j,” to be assigned to the ticket(s) or other product(s) being searched based on one or more of the ticket valuation techniques described hereinabove, then to step 1220 where the data processing system 100 determines an average market value, “k,” of the ticket(s) and/or product(s) being searched from the statistical computations conducted at step 1210, then to step 1222 where the data processing system 100 determines a minimum market value, “m,” of the ticket(s) and/or product(s) being searched from the statistical computations conducted at step 1210, and then to step 1228 where the data processing system 100 establishes a ticket value premium threshold, “n,” for the ticket(s) and/or product(s) being searched based on one or more of the ticket valuation techniques described hereinabove. Thereafter at step 1226, the data processing system evaluates the expression k≦j*n to compare the average market value of the ticket(s) and/or product(s) being requested with the product of the point value and ticket value premium threshold. If the average market value, k, is less than or equal to this product, the process 1200 advances to step 1232 where the data processing system 100 offers to acquire the ticket or tickets and/or other products for the price “m” on behalf of the member, and the process 1200 thereafter advances to the display ticket availability process block 1100 along path “M” (step 1230). If, at step 1226, the data processing system 100 determines that the average market value, k, is greater than the product of the point value and ticket value premium threshold (j*n), the process 1200 advances to step 1224 where the data processing system 100 determines that it will not consider acquiring the ticket or tickets and/or other products on behalf of the member, and the process 1200 thereafter advances to the display ticket availability process block 1100 along path “M” (step 1230).

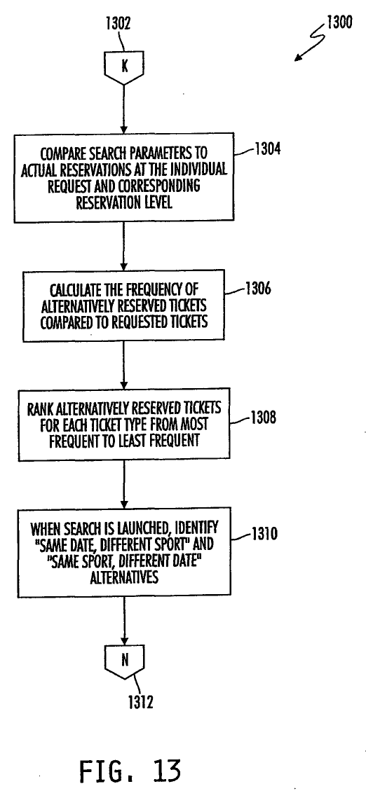

Referring now to FIG. 13, a flowchart of one illustrative embodiment of the alternatives process block 1300 of FIG. 2 is shown. In the illustrated embodiment, the process block 1300 is accessed from the ticket search process block 1000 along path “K” (step 1302), and thereafter at step 1304 the data processing system 100 compares the search request parameters from the ticket search process 1000 to ticket(s) and/or product(s) subsequently reserved by the member. Thereafter at step 1306, the data processing system 100 computes the reservation frequencies of specific alternative ticket(s) and/or other product(s) for each requested ticket type. Thereafter at step 1308, the data processing system 100 ranks the computed frequencies from most frequent to least frequent. When a search is launched by the ticket search process block 1000, the process 1300 advances to step 1310 where the data processing system 100 identifies appropriate alternatives, e.g., same date, different sport and/or same sport, different date, for those specific search parameters. Thereafter at step 1312, the process 1300 advances to the display ticket availability process block 1100 along path “N.”

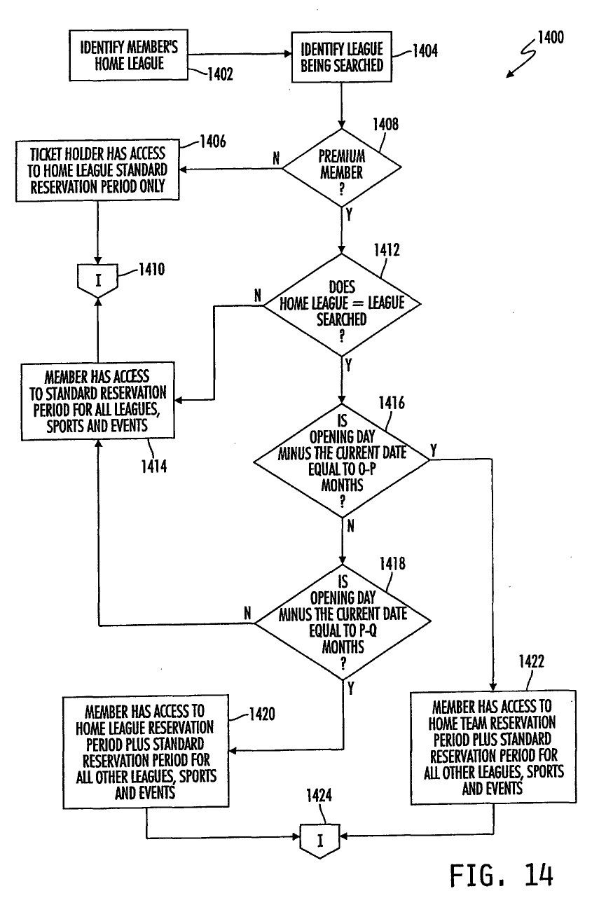

Referring now to FIG. 14, a flowchart of one illustrative embodiment of the reservation windows process block 1400 of FIG. 2 is shown. The reservation windows process block 1400 generally defines rules for operation of the reservation windows during which certain tickets may be reserved only by certain subsets of ticket holders. The process block 1400 begins at step 1402 where the data processing system 100 determines, for example, from the database of ticket ownerships 130 and/or database of member accounts 126, the member's home league. Thereafter at step 1404, the data processing system 100 identifies the league being searched from, for example, search parameters established in the operation of the ticket search process block 1000. Thereafter at step 1408, the data processing system 100 determines, for example, from the database of member accounts 126, whether the member is a premium member. If not, the process 1400 advances to step 1406 where the member is identified as having access in the system 100 only to tickets for the members home league standard reservation period. The process 1400 thereafter advances to the ticket search process block 1000 and to the display ticket availability process block 1100 along path “I” (step 1410).

If, at step 1408, the data processing system 100 determines that the member is a premium member, the process 1400 advances to step 1412 where the data processing system 100 determines whether the member's home league corresponds the league for which tickets and/or other products are being searched. If so, the data processing system 100 determines whether the date of the opening day of the league for which tickets and/or other products are being searched minus the current date is within a predefined range of months. If so, the process 1400 advances to step 1422 where the data processing system 100 identifies the member as having access to their home team tickets for a predefined home team reservation period, and access to all other leagues, sports and events for a predefined standard reservation period. From step 1422, the process 1400 advances to the ticket search process block 1000 and to the display ticket availability process block 1100 along path “I” (step 1424).

If, at step 1416, the data processing system 100 determines that the date of the opening day of the league for which tickets and/or other products are being searched minus the current date is not within the predefined range of months, the process 1400 advances to step 1418 where the data processing system 100 determines whether the date of the opening day of the league for which tickets and/or other products are being searched minus the current date is within another predefined number of months different than the predefined range of months defined at step 1416. If so, the process 1400 advances to step 1420 where the data processing system 100 identifies the member as having access to their home league tickets for a predefined home league reservation period, and access to all other leagues, sports and events for the predefined standard reservation period. From step 1420, the process 1400 advances to the ticket search process block 1000 and to the display ticket availability process block 1100 along path “I” (step 1424).

From the “No” branch of step 1412, and from the “No” branch of step 1418, the process 1400 advances to step 1414 where the data processing system 100 identifies the member as having access to all leagues, sports and events for the predefined standard reservation period. The process 1400 advances from step 1414 to the ticket search process block 1000 and to the display ticket availability process block 1100 along path “I” (step 1410).

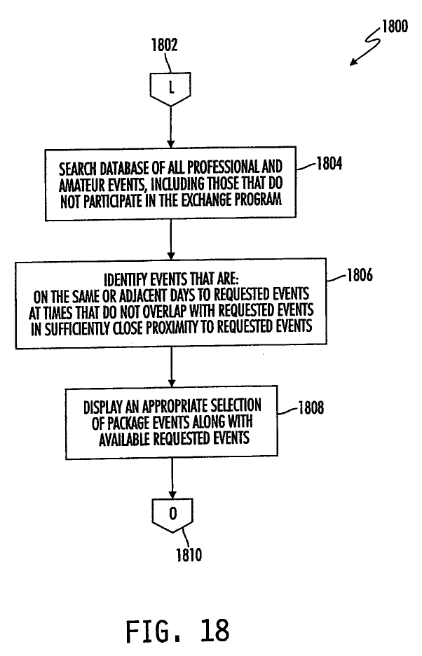

Referring now to FIG. 18, a flowchart of one illustrative embodiment of the ticket packaging process block 1800 of FIG. 2 is shown. In the illustrated embodiment, the process block 1800 is accessed from the ticket search process block 1000 along path “L” (step 1802), and thereafter at step 1804 the data processing system 100 searches one or more available databases of all professional and amateur events including those that do not participate in the event ticket exchange system 50 but that could be acquired on the member's behalf and reserved with points, cash or both. Thereafter at step 1806, the data processing system 100 identifies events, based on the parameters of the member's request that are “close” to the requested event, in terms of both date and physical proximity. Thereafter at step 1808, such) close events are displayed to the member along with available requested events in the member's search results. Thereafter at step 1810, the process 1800 advances to the display ticket availability process 1100 along path “O.”

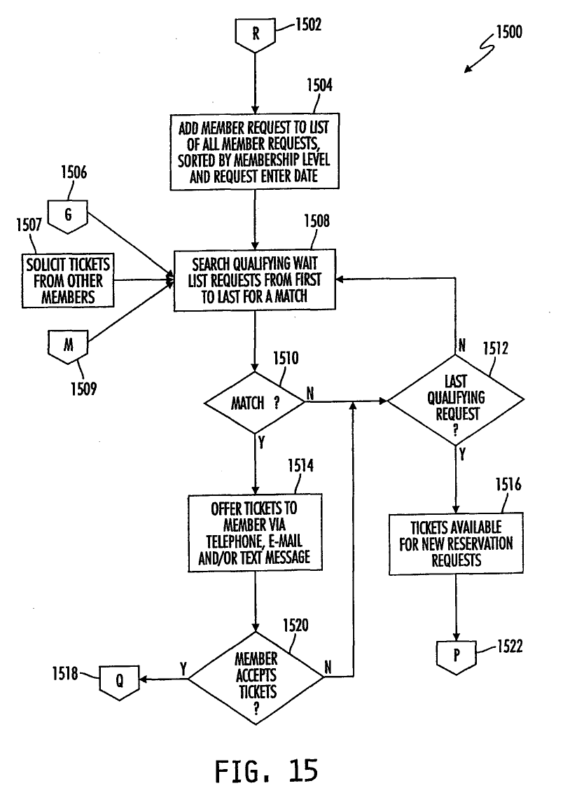

Referring now to FIG. 15, a flowchart of one illustrative embodiment of the on-going search request process block 1500 of FIG. 2 is shown. The process block 1500 is generally operable to create and maintain a wait list for tickets requested by members that are currently unavailable, and to conduct on-going ticket searches from the wait list. In the illustrated embodiment, the process block 1500 is accessed from the display ticket availability process block 1100 along path “R” (step 1502), and thereafter at step 1504 the data processing system 100 adds the member's ticket request to the wait list of all such member requests, which is then sorted by membership level and request date. Thereafter at step 1508, the data processing system searches qualifying wait list requests for matches in order from the oldest request to the most recent, first for the highest membership level and proceeding in order to the lowest membership level. Step 1508 is also accessed from the ticket management process block 500 along path “G,” the evaluation for ticket acquisition process block 1200 along path “M,” and step 1507 of FIG. 15, whereby other ticket holders/members who own ticket usage rights to one or more tickets that could, partially or completely, fulfill a wait list request are contacted so as to encourage redemption of the requested ticket or tickets.

Following step 1508, the process 1500 advances to step 1510 where the data processing system 100 determines whether a match resulted from the search of step 1508. If so, the process 1500 advances to step 1514 where the data processing system 100 offers the ticket(s) resulting from the search of step 1508 to the member. Thereafter at step 1520, if the member accepts the ticket(s), the process 1500 advances to the ticket reservation and frequent user process block 1600 along path “Q.” If the member does not accept the ticket(s) at step 1520, and if the search of step 1508 does not produce a match, the process 1500 advances to step 1512 where the data processing system 100 determines whether the last qualifying wait list request has been processed. If not, the process 1500 loops back to step 1508 to conduct another search. If, at step 1512, the data processing system 100 determines that the last qualifying wait list request has been processed, the process 1500 advances to step 1516 where the data processing system 100 makes tickets available for new reservation requests. Thereafter at step 1522, the process 1500 advances to the display ticket availability process block 1100 along path “P.”

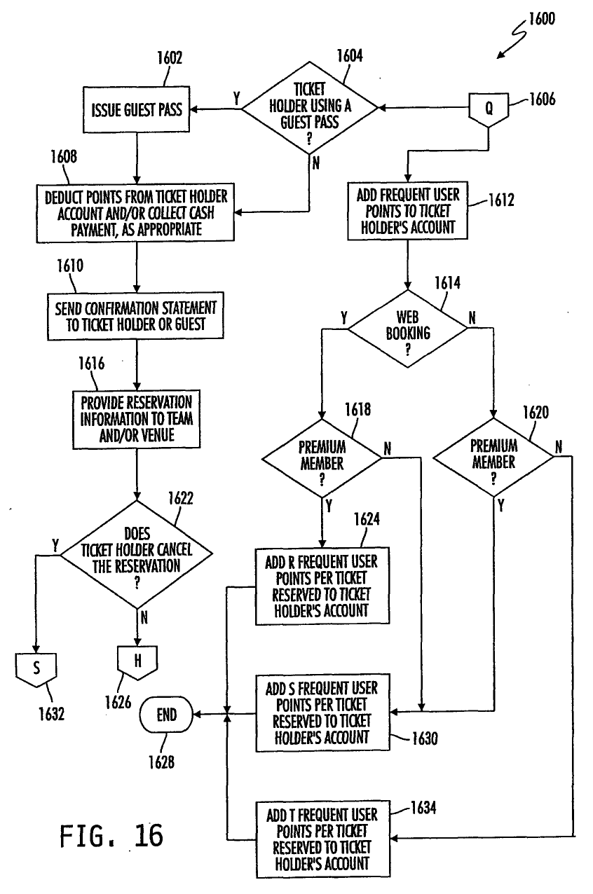

Referring now to FIG. 16, a flowchart of one illustrative embodiment of the ticket reservation and frequent user process block 1600 of FIG. 2 is shown. In the illustrated embodiment, the process block 1600 is accessed from the display ticket availability process block 1100 along path “Q” (step 1606), and thereafter at step 1604 the data processing system 100 determines whether the ticket holder/member is using a guest pass to allow another person to use their reservation. If so, the data processing system 100 issues a guest pass to the ticket holder's/member's guest at step 1602. From step 1602 the process 1600 advances to step 1608 where the data processing system 100 deducts points from the ticket holder's/member's account and/or collects cash payment, as appropriate, based on the value of the reserved ticket.

From step 1608, the process 1600 advances to step 1610 where the data processing system 100 sends a confirmation statement to the ticket holder/member and/or guest. Thereafter at step 1616, the data processing system provides the ticket reservation information to the appropriate team and/or venue. Thereafter at step 1622, the data processing system 100 determines whether the ticket holder/member has canceled the reservation. If so, the process 1600 advances to the reservation cancellation process block 1700 along path “S” (step 1632). Otherwise, the process 1600 advances to an appropriate one of the ticket fulfillment process blocks 600, 700, 800 (step 1626).

Step 1606 also advances to step 1612 where the data processing system 100 adds frequent user points to the ticket holder's/member's account according to steps 1618, 1620, 1624, 1630 and 1634. Thereafter at step 1614, the data processing system 100 determines whether the ticket reservation is being made via over the World Wide Web via the system's web server 116. If so, the process 1600 advances to step 1618 where the data processing system 100 determines whether the ticket holder/member is a premium member. If so, the process 1600 advances to step 1624 where the data processing system 100 adds a number, “r,” of frequent user points per ticket reserved to the ticket holder's/member's account. If not, the process 1600 advances to step 1630 where the data processing system 100 adds a number, “s,” of frequent user points per ticket reserved to the ticket holder's/member's account. If, at step 1614 the data processing system determines that the ticket reservations are not being made via the web server 116, the process 1600 advances to step 1620 where the data processing system 100 determines whether the ticket holder/member is a premium member. If so, the process 1600 advances to step 1630 where the data processing system 100 adds the number, “s,” of frequent user points per ticket reserved to the ticket holder's/member's account. If not, the process 1600 advances to step 1634 where the data processing system 100 adds a number, “t,” of frequent user points per ticket reserved to the ticket holder's/member's account. The process 1600 ends at step 1628 following execution of steps 1624, 1630 and 1634.

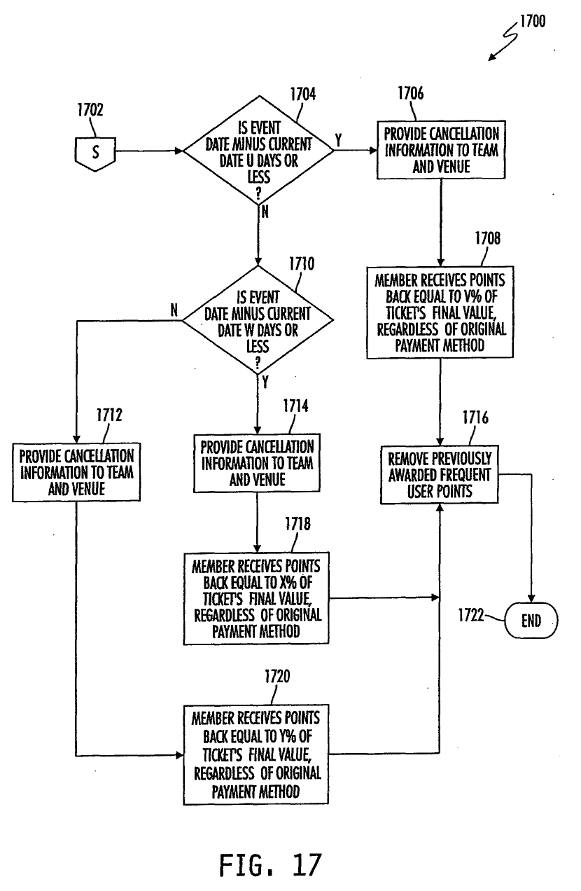

Referring now to FIG. 17, a flowchart of one illustrative embodiment of the reservation cancellation process block 1700 of FIG. 2 is shown. In the illustrated embodiment, the process block 1700 is accessed from the ticket reservation and frequent user process block 1600 along path “S” (step 1702), and thereafter at step 1704 the data processing system 100 determines whether the event date minus the current date is less than or equal to a predefined number of days, “u.” If so, the data processing system 100 provides ticket cancellation information to the appropriate team and venue. Thereafter at step 1708, the data processing system credits the member's account with a number of points equal to a predefined percentage, v %, of the ticket's final value as determined by the process block 900. Thereafter at step 1716, the data processing system 100 removes any previously awarded frequent user points from the member's account. Following step 1716, the process 1700 ends at step 1722.

If, at step 1704, the data processing system 100 determines that the event date minus the current date is greater than “u” days, the process 1700 advances to step 1710 where the data processing system 100 determines whether the event date minus the current date is less than or equal to another predefined number of days, “w.” If so, the process advances to step 1714 where the data processing system 100 provides ticket cancellation information to the appropriate team and venue. Thereafter at step 1718, the data processing system credits the member's account with a number of points equal to another predefined percentage, x %, of the ticket's final value as determined by the process block 900. Thereafter at step 1716, the data processing system 100 removes any previously awarded frequent user points from the member's account. Following step 1716, the process 1700 ends at step 1722.

If, at step 1710, the data processing system 100 determines that the event date minus the current date is greater than “w” days, the process 1700 advances to step 1712 where the data processing system 100 provides ticket cancellation information to the appropriate team and venue. Thereafter at step 1720, the data processing system credits the member's account with a number of points equal to yet another predefined percentage, y %, of the ticket's final value as determined by the process block 900. Thereafter at step 1716, the data processing system 100 removes any previously awarded frequent user points from the member's account. Following step 1716, the process 1700 ends at step 1722. Illustratively, the parameters “u,” “w,” “v,” “x,” and “y” may be selected so as the difference between the event date and the current date increases the lesser the greater the refund to the member's account.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

1. A method of exchanging event tickets, the method comprising:
determining a monetary value of at least one event ticket offered for redemption by a ticket holder,
assigning a number of points equivalent to the monetary value of the at least one event ticket, and
offering the number of points to the ticket holder in exchange for the at least one event ticket.

2. The method of claim 1 further comprising:
allowing the ticket holder to select or reserve at least one alternate event ticket, other product or service, and
allowing the ticket holder to exchange one or more of the number of points for the selected or reserved at least one alternate event ticket, other product or service.

3-6. (canceled)

7. The method of claim 1 further comprising establishing a member account for the ticket holder that the ticket holder may use to exchange event tickets.

8. The method of claim 7 further comprising:
evaluating a status of the member account, and
executing the determining, assigning and offering steps only if the status of the member account is in good standing.

9. The method of claim 1 further comprising:
providing the ticket holder with a list of event tickets owned by the ticket holder, and
allowing the ticket holder to select from the list of event tickets the at least one event ticket to offer for redemption.

10. The method of claim 1 wherein determining a monetary value of the at least one event ticket offered for redemption by the ticket holder comprises determining a core point value of the at least one event ticket offered for redemption.

11. (canceled)

12. The method of claim 1 further comprising:
determining a demand level of the at least one event ticket, and
determining a category of the number of points based on the demand level,
wherein assigning the number of points comprises assigning the number of points in the determined category of the number of points.

13. The method of claim 12 wherein determining the demand level comprises:
determining whether the event corresponding to the at least one event ticket satisfies any of a number of predefined criteria, and
determining the demand level as a function of the number of predefined criteria satisfied by the event corresponding to the at least one event ticket.

14-18. (canceled)

19. The method of claim 1 further comprising allowing the ticket holder to classify the at least one event ticket offered for redemption as a restricted redemption or an unrestricted redemption.

20. The method of claim 19 further comprising assigning the number of points equivalent to the monetary value of the at least one event ticket to the ticket holder upon redemption of the at least one event ticket if the redemption has been classified by the ticket holder as an unrestricted redemption.

21. The method of claim 19 further comprising assigning the number of points equivalent to the monetary value of the at least one event ticket to the ticket holder only after the at least one event ticket has been reserved by another if the redemption has been classified by the ticket holder as a restricted redemption.

22. The method of claim 1 further comprising requiring the ticket holder to provide the at least one redeemed event ticket to a ticket exchange system.

23. The method of claim 22 further comprising analyzing the at least one redeemed ticket provided by the ticket holder to determine whether the at least one redeemed ticket provided by the ticket holder matches the at least one ticket offered for redemption by the ticket holder.

24. The method of claim 23 further comprising removing the number of points from the ticket holder's account if the at least one ticket redeemed by the ticket holder does not match the at least one ticket offered for redemption by the ticket holder.

25. The method of claim 22 further comprising analyzing the at least one redeemed ticket provided by the ticket holder to determine whether the at least one redeemed ticket provided by the ticket holder was received from the ticket holder within a specified time period.

26-35. (canceled)

36. The method of claim 1 further comprising allowing members to conduct or request a search for one or more event tickets.

37. The method of claim 36 wherein the search conducted or requested by the member includes identification of a specific event type or league.

38-39. (canceled)

40. The method of claim 36 wherein the search conducted or requested by the member includes identification of a specific a city in which the event corresponding to the one or more event tickets being searched is scheduled to take place.

41. The method of claim 36 wherein the search conducted or requested by the member includes identification of a specific a venue in which the event corresponding to the one or more event tickets being searched is scheduled to take place.

42. (canceled)

43. The method of claim 36 wherein the search conducted or requested by the member includes identification of a specific number of tickets.

44-84. (canceled)
